(19) United States
(12) Patent Application Publication
(10) Pub. No.: US 2013/0171399 A1
(43) Pub. Date: Jul. 4, 2013

(54) DIELECTRIC ADHESIVE FILM FOR ELECTRONIC PAPER DISPLAY DEVICE

(71) Applicants: Dong Han Kho, Daegu (KR); Sang Hoon Lee, Gumi-si (KR); Chang Ik Hwang, Daegu (KR); Yeon Soo Kim, Seongnam-si (KR)

(72) Inventors: Dong Han Kho, Daegu (KR); Sang Hoon Lee, Gumi-si (KR); Chang Ik Hwang, Daegu (KR); Yeon Soo Kim, Seongnam-si (KR)

(73) Assignee: Toray Advanced Materials Korea Inc., Gumi-si, Kyungsangbuk-do (KR)

(21) Appl. No.: 13/699,253

(22) PCT Filed: Oct. 19, 2011
(86) PCT No.: PCT/KR11/07793

§ 371 Date: Nov. 20, 2012

(30) Foreign Application Priority Data
Aug. 8, 2011 (KR) 10-2011-0078601

(51) Int. Cl. C09J 133/14

(52) U.S. Cl. CPC C09J 133/14
USPC 428/40.2; 428/220; 428/41.5

(57) ABSTRACT

A dielectric adhesive film for an electronic paper display device. A lower electrode to which voltage is applied and an image upper electrode coated with charged particles whose colors are changed depending on the applied voltage are attached to the adhesive film. Thickness of the adhesive film is controlled to be uniform and constant, and a resistance value in the thickness direction of the adhesive film, i.e., a resistance value in the direction where an electric field is formed, is controlled without changing adhesive properties and reliability as the thickness of the adhesive film is controlled. Since loss of the applied voltage is minimized and the charged particles are freely driven, driving performance of the display device is excellent although a high voltage is not applied in driving a flexible display device, such as a flexible LED, an organic electro luminescence (EL) element including an electronic paper, and the like.

### CROSS-REFERENCE TO RELATED APPLICATIONS

This application is a National Stage application of International Application No. PCT/KR2011/007793, filed on Oct. 19, 2011, which claims priority of Korean application Serial Number 10-2011-0078601 filed on Aug. 8, 2011, both of which are incorporated herein by reference in their entireties.

### BACKGROUND OF THE INVENTION

1. Field of the Invention

The present invention relates to a dielectric adhesive film for an electronic paper display device, and more specifically, to a dielectric adhesive film for an electronic paper display device, in which a lower electrode to which voltage is applied and an image upper electrode coated with charged particles whose colors are changed depending on the applied voltage are attached to the adhesive film. Thickness of the adhesive film is controlled to be uniform and constant, and as the thickness of the adhesive film is controlled, a resistance value in the thickness direction is controlled while maintaining adhesive properties and reliability. Therefore, loss of the applied voltage is minimized, and driving performance of a flexible display device is enhanced although a high voltage is not applied when the display device is driven.

2. Background of the Related Art

As networks are widely spread recently, conventional documents having a shape of a printed material are replaced with documents created by a method of implementing a flexible display device. Furthermore, this is expanded into the market of electronic publishing industry including the markets of books, magazines and the like.

However, although the documents created as such are read through a CRT or a liquid crystal display of a computer in order to view the information recorded in the documents, the CRT or the liquid crystal display of the computer is a display device of a light emitting type, and thus it is difficult for a user to view the information for a long time since it is easy to feel fatigue if the user uses the display device for an extended period of time, and a place for viewing the information is limited to a location where the computer, LCD or the like is installed.

Although a portable display device may be used as an alternative owing to distribution of notebook type computers, viewing the information for an extended period of time is limited due to the problem of power consumption since the portable display device also uses a light emitting display method based on backlight.

Accordingly, reflective type liquid crystal displays that can be driven with low power consumption are developed and released. However, the reflective type liquid crystal displays have remarkably low visibility in white color of liquid crystal and are easy to feel fatigue compared with printed materials of paper due to low reflectance, and thus they still do not solve the problems described above so as to be used for reading for an extended period of time.

Therefore, in order to solve the problems described above, the so-called electronic papers are developed recently.

The electronic papers are core elements for implementing a flexible display, which make a motion when an electromagnetic field is applied to a conductive material. That is, data are expressed by changing arrangement of directions of charged particles after distributing the charged particles between thin film flexible substrates, based on changes of polarities of the electromagnetic field.

In this case, if the arrangement of directions of the charged particles occurs at any polarity, an image is maintained as is since positions of the particles are unchanged due to memory effect although voltage is removed, and thus an effect of printing the image on a paper with ink may be obtained. Accordingly, since the electronic papers do not have self-emitting light, visual fatigue is remarkably lowered, and thus it is possible to view documents with comfort like reading a real book. In addition, since flexibility and portability are secured by using a flexible substrate, the electronic papers are highly expected as a future flat panel display technique.

In addition, if an image is implemented once, it is maintained for an extended period of time as described above until the substrate is re-set, and thus power consumption is very low, and the electronic paper may be conveniently used as a portable display device.

Since manufacturing cost of the electronic papers is extremely low compared with conventional flat panel displays, and background illumination or continuous recharge of battery is not needed, the electronic papers may be driven with extremely low energy, and thus they are remarkably superior from the aspect of energy efficiency.

Owing to the advantages described above, the electronic papers are applicable to a variety of fields, including electronic books and newspapers having paper-like surfaces and mobile illustrations, reusable paper displays for cellular phones, disposable TV screens, electronic wallpapers and the like, and therefore, a vast potential market may be expected.

In a flexible display device such as the electronic paper described above, an upper electrode having charged particles of an image should be combined with a lower electrode to which voltage is applied, and at this point, the flexible display device is manufactured by inserting an adhesive film between the two electrodes.

However, there may be a loss in driving voltage or inconsistent driving may occur due to the adhesive film, and a charged particle layer of image may be damaged due to a heating and pressing process in the process of manufacturing the adhesive film. Therefore, it is required to manufacture an adhesive film having a low voltage loss that can be accomplished owing to a uniform adhesive means of the adhesive film.

For example, Korean Laid-opened Patent No. 2006-0032111 discloses a method of bonding barrier ribs and a substrate in a thermal bonding method after transcribing an adhesive means on the top and bottom of a transparent electrode using adhesive means that have different transition temperatures.

However, since instability of the barrier ribs, a pigment or a toner increases while they pass through the thermal bonding process twice, it is difficult to practically utilize the method.

Korean Laid-opened Patent No. 2006-0067006 discloses a bonding method using an ultraviolet lamp, in which an ultraviolet curing adhesive is used as an adhesive means. However, since filled-in pigment or toner may be fixed to the adhesive layer and most of the pigment used in this method is stable to ultraviolet rays, a function of blocking ultraviolet rays of outside is required, and thus this bonding method is unrealistic.

An attempt for improving the problems of conventional thick adhesive films has been made in Korean Laid-opened Patent No. 2007-0041197, in which an EVA adhesive is implemented as a thin film using a vacuum evaporation method. However, it is difficult to apply a desired amount of EVA adhesive, which is an organic material, at a desired position using the vacuum evaporation method.

Korean Laid-opened Patent No. 2011-0032357 discloses a technique for bonding barrier ribs and a substrate at a desired position using a tape configured with a flexible film placed in the middle and two adhesive layer attached on both sides of the flexible film.

However, although the barrier ribs and the substrate may be attached at a desired position, a resolution like a display material cannot be achieved using a double-sided tape.

In addition, due to strong adhesiveness, the adhesive layer applied to an electronic paper among the flexible displays described above does not allow a re-work on each material if the pigment or toner is defective at the time of attachment or if there is a problem in the upper or lower electrode. Accordingly, a loss occurred when manufacturing the adhesive film is enormous since relatively expensive Thin Film Transistors (TFTs) cannot be used. Furthermore, this invention almost does not refer to a distance between the adhesive layer and the upper or lower electrode, or a material of the adhesive layer, and thus a method for overcoming a loss occurred in the driving voltage is not proposed.

Therefore, the presently claimed invention solves the conventional problems and, as a result, completed the present invention by confirming that the adhesive film can be manufactured without a loss in the driving voltage. In the present invention, a lower electrode to which voltage is applied and an image upper electrode coated with charged particles whose colors are changed depending on the applied voltage are attached to the adhesive film, and thickness of an adhesive film is controlled to be uniform and constant, and as the thickness of the adhesive film is controlled, a resistance value in the thickness direction is controlled.

### SUMMARY OF THE INVENTION

Accordingly, the present invention has been made in view of the above-mentioned problems occurring in the prior art, and it is an object of the present invention to provide a dielectric adhesive film for an electronic paper display device, which is controlled to minimize a loss in driving voltage of a flexible display device without changing adhesive properties and reliability.

To accomplish the above objects, according to an aspect of the present invention, there is provided a dielectric adhesive film for an electronic paper display device, the dielectric adhesive film being controlled and laminated to have a thickness of 4.0 to 50.0 μm to attach an upper electrode coated with charged particles and a lower electrode to which voltage is applied.

In the adhesive film of the present invention, an electrical resistance value in a direction where an electric field is formed satisfies a range of 1.0×10⁴ to 9.9×10⁹Ω as the thickness of an adhesive layer is controlled.

Further specifically, in the adhesive film of the present invention, an acrylic adhesive layer is formed on a silicon release coating surface of a polyester-based high release sheet to have a thickness of 4.0 to 50.0 μm, and a polyester-based low release sheet is laminated on the acrylic adhesive layer.

A base resin used in the acrylic adhesive layer is produced using an acrylate copolymer, and further preferably, the base resin is produced by copolymerizing 80 to 98% by weight of a monomer without a cross-linkable functional group and 2 to 20% by weight of a monomer having a cross-linkable functional group.

The monomer that does not have a cross-linkable functional group is an (meta)acrylic acid ester having an alkyl group of 1 to 20 carbon atoms in the ester portion selected from a group consisting of a methyl(meta)acrylate, ethyl(meta)acrylate, n-propyl(meta)acrylate, n-butyl(meta)acrylate, pentyl(meta)acrylate, hexyl(meta)acrylate, cyclohexyl(meta)acrylate, 2-ethylhexyl(meta)acrylate, isooctyl(meta)acrylate, decyl(meta)acrylate, dodecyl(meta)acrylate, myristyl(meta)acrylate, palmityl(meta)acrylate, stearyl(meta)acrylate, or n-tetradecyl(meta)acrylate; an acrylic monomer of acrylonitile; or a biacrylic monomer containing vinyl acetate or styrene; or combination thereof.

In addition, the monomer having a cross-linkable functional group is a single or a mixture of two or more monomers selected from: an acryl monomer containing any one hydroxy group selected from a group of 2-hydroxy ethyl(meta)acrylate, 2-hydroxy propyl(meta)acrylate, 4-hydroxy butyl(meta)acrylate, 6-hydroxy hexyl(meta)acrylate, 2-hydroxy ethylene glycol(meta)acrylate, and 2-hydroxy propylene glycol(meta)acrylate; an acryl monomer containing a carboxyl group of any one selected from a group of (meta)acryl acid, maleic acid, and fumaric acid; and any one nitrogen-containing acryl monomer selected from a group of acryl amid, N-vinyl pyrrolidone, and N-vinyl caprolactam.

Furthermore, the acrylic adhesive layer of the present invention contains 0.05 to 5 parts by weight of a single or a mixture form selected from an epoxy-based cross-linking agent or a multi-functional isocyanate-based cross-linking agent, with respect to 100 parts by weight of a base resin produced using an acrylate copolymer.

In addition, the acrylic adhesive layer further contains one or more of anti-static agents selected from a conductive organic-inorganic particle, organic-inorganic salt, and an ionic material, and accordingly, electrical characteristics are improved at the same thickness by changing dielectric properties.

### BRIEF DESCRIPTION OF THE DRAWINGS

FIG. 1 is a view illustrating a method of measuring a resistance value in the thickness direction, for an adhesive film of the present invention.

DESCRIPTIONS OF SYMBOLS

| | |
|---|---|
| 10: Upper electrode | 20: Adhesive layer |
| 30: Lower layer | |

### DETAILED DESCRIPTION OF THE PREFERRED EMBODIMENT

Hereinafter, the present invention will be described in detail.

The present invention provides a dielectric adhesive film for an electronic paper display device, in which the dielectric adhesive film is controlled and laminated to have a thickness of 4.0 to 50.0 μm to attach an upper electrode coated with charged particles and a lower electrode to which voltage is applied.

More specifically, since resistance of the adhesive film is measured in the thickness direction, the resistance is sensitively changed depending on the thickness structure of the adhesive film. Therefore, if the adhesive film is formed to be thinner than 4.0 μm, electrical characteristics are superior. However, release force is lowered, and interfacial fracture is induced from the viewpoint of adhesive reliability, and thus separation of electrode occurs. On the other hand, the adhesive film may be designed to be thick in order to grant adhesive reliability. However, if the adhesive film is formed excessively thick to be more than 50.0 μm, the electrical characteristics are degraded. Accordingly, in order to grant adhesive reliability while maintaining the superior electrical characteristics in consideration of the trade-off relation between the adhesive reliability and the electrical characteristics, the adhesive reliability and the electrical characteristics may be optimized when the thickness of the adhesive film is between 4.0 to 50.0 μm, further preferably between 7.0 to 20.0 μm.

Particularly, in the dielectric adhesive film for an electronic paper display device of the present invention, a resistance value in the thickness direction of the adhesive film, i.e., a resistance value in the direction where an electric field is formed, may be controlled without changing adhesive properties and reliability by controlling a structural property, i.e., thickness of the adhesive film.

That is, the dielectric adhesive film of the present invention is controlled to have a resistance value within a range of 1.0×10⁴ to 9.9×10⁹Ω in the thickness direction of the adhesive film based on the thickness control described above. At this point, if the resistance value is lower than 1.0×10⁴Ω in the thickness direction of the adhesive film, a resistance value between the upper and lower electrodes is too low to form an electric field. Therefore, a current may flow through the adhesive film, or electrical shock may occur, and thus the adhesive film should function as an insulator. If the resistance value is higher than 9.9×10⁹Ω, although magnitude of the voltage applied to the lower electrode is changed, a voltage required to drive an image film configured with cells containing charged particles may not be obtained due to the extremely high resistance value, and thus there will be a great loss in voltage. Further preferably, it is reasonable to have a resistance value within a range of 1.0×10⁵ to 9.9×10⁹Ω.

Specifically, the adhesive film of the present invention has a structure including an acrylic adhesive layer formed on a silicon release coating surface of a polyester-based high release sheet to have a thickness of 4.0 to 50.0 μm and a polyester-based low release sheet laminated on the acrylic adhesive layer, and each of the release sheets is released so as to be applied when the adhesive film is applied to a product.

Although one or a mixture of two or more resins selected from a group of a natural rubber resin, a synthetic rubber resin, an acrylic resin, and a silicon resin may be used as a base resin of the adhesive layer used in the adhesive film, an acrylic adhesive layer using the acrylic resin having superior optical characteristics is used in the present invention.

At this point, the base resin comprising an acrylate copolymer is produced by copolymerizing 80 to 98% by weight of a monomer without a cross-linkable functional group and 2 to 20% by weight of a monomer having a cross-linkable functional group.

Further preferably, a copolymer comprising 85 to 98% by weight of a monomer without a cross-linkable functional group and 2 to 15% by weight of a monomer having a cross-linkable functional group is used as the base resin, and at this point, the base resin can be manufactured to have a weight-average molecular weight of 800,000 or higher.

At this point, if the monomer that does not have a functional group is less than 80% by weight, there may be a problem in storage stability of the adhesive since the number of functional groups is relatively large, whereas if the monomer that does not have a functional group is higher than 98% by weight, a smooth reaction may not be expected since reactivity of the functional group is notably lowered, and it may not be regarded as a proper copolymer since other additives such as a catalyst need to be contained.

The monomer that does not have a cross-linkable functional group is not specially limited if it is, for example, a (meta)acrylic acid ester monomer, and (meta) acrylic acid ester having an alkyl group of 1 to 20 carbon atoms in the ester portion may be used. Specifically, examples of the (meta)acrylic acid ester having an alkyl group of 1 to 20 carbon atoms in the ester portion include methyl(meta)acrylate, ethyl(meta)acrylate, n-propyl(meta)acrylate, n-butyl(meta)acrylate, pentyl(meta)acrylate, hexyl(meta)acrylate, cyclohexyl(meta)acrylate, 2-ethylhexyl(meta)acrylate, isooctyl(meta)acrylate, decyl(meta)acrylate, dodecyl(meta)acrylate, myristyl(meta)acrylate, palmityl(meta)acrylate, stearyl(meta)acrylate, n-tetradecyl(meta)acrylate, and the like. Other than these, a single or a mixture of two or more monomers selected from an acrylic monomer of acrylonitile or a biacrylic monomer containing vinyl acetate or styrene may be used.

In addition, the monomer including a cross-linkable functional group preferably includes at least one of a hydroxyl group, a carboxyl group, an amino group, and an amide group as a functional group. Specific examples of the monomer includes a single or a mixture of two or more monomers selected from: an acryl monomer containing any one hydroxy group selected from a group of 2-hydroxy ethyl(meta)acrylate, 2-hydroxy propyl(meta)acrylate, 4-hydroxy butyl(meta) acrylate, 6-hydroxy hexyl(meta)acrylate, 2-hydroxy ethylene glycol(meta)acrylate, and 2-hydroxy propylene glycol(meta)acrylate; an acryl monomer containing a carboxyl group of any one selected from a group of (meta)acryl acid, maleic acid, and fumaric acid; and any one nitrogen-containing acryl monomer selected from a group of acryl amide, N-vinyl pyrrolidone, and N-vinyl caprolactam.

The acrylic adhesive layer described above contains 0.05 to 5 parts by weight of a single or a mixture form selected from an epoxy-based cross-linking agent or a multi-functional isocyanate-based cross-linking agent, with respect to 100 parts by weight of the base resin comprising an acrylate copolymer.

At this point, the cross-linking agent is mixed to enhance durability of the copolymer, and if contents of the cross-linking agent are less than 0.05 parts by weight, the cross-linking agent is unable to smoothly react with the functional group contained in the acrylic copolymer, and internal cohesiveness of the adhesive cannot be strengthened. On the other hand, if contents of the cross-linking agent exceed 5 parts by weight, uniform properties cannot be shown since storage stability is lowered while processing the adhesive, and this is undesirable since a retarder for delaying reaction should be additionally added or additional management for storing the adhesive at a low temperature should be required in order to delay reactivity between the acrylic copolymer and a mixture of cross-linking agents. Therefore, contents of the cross-linking agent of 1.0 part by weight are used as the most preferable condition in the present invention. However, it is apparent that the contents may be changed within the range of contents proposed above.

In addition, the epoxy-based cross-linking agent used in the present invention may be an epoxy-based resin of a bisphenol A-epichlorohydrin type, for examples, ethylene glycol diglycidyl ether, polyethylene glycol diglycidyl ether, glycerin diglycidyl ether, glycerin triglycidyl ether, 1,6-Hexanediol diglycidyl ether, trimethylolpropane triglycidyl ether, diglycidyl aniline, N,N,N′,N′-tetraglycidyl-m-xylene diamine, or a mixture thereof.

In addition, the multi-functional isocyanate-based cross-linking agent used as another cross-linking agent may be a tolylene diisocyanate, diphenylmethane diisocyanate, hexamethylene diisocyanate, trimethylolpropane additive of the tolylene diisocyanate, or a mixture thereof.

In addition, the acrylic adhesive layer may further contain one or more of anti-static agents selected from a conductive organic-inorganic particle, organic-inorganic salt, and an ionic material, and electrical characteristics can be improved at the same thickness by changing dielectric properties.

In the present invention, in order to enhance adhesive reliability and characteristics of the lower electrode, a single or a mixture of two or more monomers selected from compounds used as an adhesive tackifier, a platicizer, an anti-static agent, a surfactant, an antioxidant, a foaming agent, an antifoaming agent, a reinforcing agent, a coloring agent, or a filler may be further used as a general additive, in addition to the monomers and the hardeners of the acrylic adhesive.

Hereinafter, the present invention will be described in further detail through embodiments.

This is for describing the present invention further specifically. The most preferable embodiments will be described as an example, and particularly, it will be described focusing on changes of electrical resistance in the thickness direction according to control on thickness of an adhesive film, and the scope of the present invention including conditions of components required to form the adhesive layer is not limited to the embodiments.

### Embodiment 1

### Step 1: Manufacturing Base Resin of Acrylic Copolymer

A mixed composition is prepared by injecting monomers such as 33 g of 2-ethylhexylacrylate, 0.2 g of acrylic acid, 0.3 g of glycidolmethacrylate, and 15 g of methylacrylate into a chemical reactor of 500 ml, which is provided with a stirrer, a reflux condenser, a thermometer, and a nitrogen injection device, and adding 51.5 g of ethylacetate as a solvent. The mixed composition is injected by steps, such as 25 to 35% in the initial first step, 55 to 65% in a second step, and the remaining of less than 25% in a third step, and then polymerization is processed. After the polymerization is completed, 300 g of ethylacetate is added to the obtained polymer to dilute the polymer, and the desired base resin of acrylic copolymer is synthesized by making a solid of 30% by weight.

### Step 2: Manufacturing Adhesive Film

A mixture is manufactured by injecting 1.0 part by weight of 3-functional aziridine adduct as a hardener to 100 parts by weight of the acrylic copolymer, which is the base resin manufactured in step 1, and then diluting the base resin with methylethylketone and uniformly mixing them.

A uniform adhesive layer having a thickness of 5 μm is formed by coating and drying the mixture on the silicon release coating surface of a biaxially oriented polyethylene terephthalate film (product name is RPC-101 of Toray Advance Materials Inc.), which is a high release sheet.

Then, a polyethylene terephthalate film (product name is RPK-201 of Toray Advance Materials Inc.) is laminated to be used as a low release sheet on the surface where the adhesive layer is formed, and the adhesive film is stored for 7 days at room temperature to be sufficiently matured, and thus the adhesive film is completed.

### Embodiment 2

Except that the thickness of the mixture coated and dried on the silicon release coating surface of a biaxially oriented polyethylene terephthalate film in the process of manufacturing an adhesive film of step 2 in embodiment 1 is 10 μm, embodiment 2 is performed in the same manner as shown in embodiment 1.

### Embodiment 3

Except that the thickness of the mixture coated and dried on the silicon release coating surface of a biaxially oriented polyethylene terephthalate film in the process of manufacturing an adhesive film of step 2 in embodiment 1 is 15 μm, embodiment 3 is performed in the same manner as shown in embodiment 1.

### Embodiment 4

Except that the thickness of the mixture coated and dried on the silicon release coating surface of a biaxially oriented polyethylene terephthalate film in the process of manufacturing an adhesive film of step 2 in embodiment 1 is 20 μm, embodiment 4 is performed in the same manner as shown in embodiment 1.

### Embodiment 5

Except that 0.1 parts by weight of multi-wall carbon nano tube (CM-100 of Hanwha Nanotech Inc.) is further contained as an anti-static agent in the mixture diluted using methylethylketone in the process of manufacturing an adhesive film of step 2 in embodiment 1, embodiment 5 is performed in the same manner as shown in embodiment 4.

### Comparative Example 1

Except that the thickness of the mixture coated and dried on the silicon release coating surface of a biaxially oriented polyethylene terephthalate film in the process of manufacturing an adhesive film of step 2 in embodiment 1 is 3 μm, comparative example 1 is performed in the same manner as shown in embodiment 1.

### Comparative Example 2

Except that the thickness of the mixture coated and dried on the silicon release coating surface of a biaxially oriented polyethylene terephthalate film in the process of manufacturing an adhesive film of step 2 in embodiment 1 is 50 μm, comparative example 2 is performed in the same manner as shown in embodiment 1.

### Experimental Example 1

### 1. Measuring Thickness

Thickness of the adhesive film manufactured in embodiments 1 to 5 and comparative examples 1 and 2 is measured with a tool having a digital gauge of 0.001 mm (=1 μm) scale in conformance to the standard JIS Z0237 if the thickness is less than 0.1 mm, and the thickness is measured at three points at the same intervals. In order to accurately measure the thickness of the adhesive films, the thickness of the adhesive films is re-confirmed through a single image technique of FE-SEM.

### 2. Measuring Release Force

After removing the low release sheet from the adhesive film manufactured in embodiments 1 to 5 and comparative examples 1 and 2 and laminating a polyethylene terephthalate film having a thickness of 100 μm, the adhesive film is put aside for an hour at room temperature, and then a specimen having a width of 25 mm and a length of 150 mm for measuring the release force is manufactured. A glass to be used for measuring the release force is cleanly cleansed with ethyl acetate, and the high release sheet of the manufactured specimen is removed. Then, the specimen is attached to the glass using a roller of 2 Kg and put aside for an hour at room temperature. At this point, the measurement is performed using a tensile tester at an angle of 180° and at a release speed of 0.3 m/minute.

### 3. Measuring Resistance in Thickness Direction

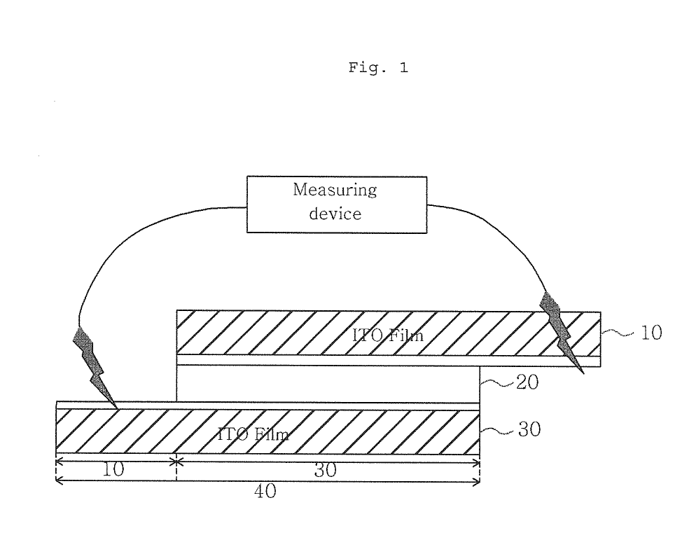

After removing the low release sheet from the adhesive film manufactured in embodiments 1 to 5 and comparative examples 1 and 2, the adhesive is laminated on a part of the ITO surface or the electrode surface of an ITO film or a transparent electrode film cut to be larger than 30 mm×40 mm. After removing the high release sheet from the laminated film, another ITO film or transparent electrode film is attached to offset the opposite ITO or transparent electrode film as shown in FIG. 1. When the adhesive film is laminated on the ITO film or transparent electrode film, a roll of 2 Kg is applied once. After the adhesive film is put aside for an hour at room temperature, both of the ITO films are grounded, and the electric resistance in thickness direction is measured.

The measuring equipment measures current of the applied voltage using a low current and high resistance measuring apparatus (High Resistance Electrometer, 6517B, manufacturer: Keithley) capable of measuring resistance even from a dielectric material. At this point, after applying DC 20V, a value of converged current is read after 30 seconds, and a resistance value of the adhesive film in the thickness direction is calculated as shown in mathematical expression 1.

Resistance value of adhesive film in thickness direction (Ω)=20(V)/Measured current(A) [Mathematical Expression 1]

### 4. Evaluating Reliability

After removing the low release sheet from the adhesive film manufactured in embodiments 1 to 5 and comparative examples 1 and 2 and laminating a polyethylene terephthalate film, the adhesive film is put aside for an hour at room temperature, and then a specimen for evaluating reliability is manufactured to be 100 mm×100 mm, and the specimen is attached to the cleansed glass using a roller of 2 Kg.

Then, after the specimen is put aside for an hour, the specimen is put into moisture and heat resistant condition of 60° C. and 90% RH and a heat resistant condition of 80° C. Then, it is observed whether or not foams are generated and edges are detached with naked eyes for 500 hours, and evaluation of reliability is recorded based on the criteria shown below.

◯: Foams are not generated or edges are not detached in the moisture and heat resistant condition and the heat resistant condition.

X: Foams are generated or edges are detached in the moisture and heat resistant condition and the heat resistant condition.

TABLE 1
Result of measuring properties of adhesive film

| | Thickness of | | Resistance | |
|---|---|---|---|---|
| | Adhesive | Release Force | Value | |
| | Film [μm] | [gf/25 mm] | [Ω] | Reliability |
| Embodiment 1 | 5 | 310 | 1.48 × 10⁷ | ◯ |
| Embodiment 2 | 10 | 650 | 5.62 × 10⁸ | ◯ |
| Embodiment 3 | 15 | 830 | 2.45 × 10⁹ | ◯ |
| Embodiment 4 | 20 | 1,020 | 4.56 × 10⁹ | ◯ |
| Embodiment 5 | 20 | 810 | 4.56 × 10⁵ | ◯ |
| Comparative | 3 | 76 | 3.75 × 10⁵ | X |
| example 1 | | | | |
| Comparative | 50 | 1,732 | 4.56 × 10¹¹ | ◯ |
| example 2 | | | | |

As is confirmed from Table 1, although the same adhesive material is used, electrical characteristics are changed depending on the thickness of the adhesive, i.e., depending on a distance between the image upper electrode containing charged electrophoretic particles and the lower electrode.

Specifically, it is confirmed that the resistance value in the thickness direction decreases as the thickness of the adhesive layer of the adhesive film decreases (embodiments 1 to 4). On the other hand, if the adhesive layer of the adhesive film is excessively thin, there is a problem in adhesive reliability between two materials (comparative example 1). In addition, if the adhesive layer is formed to be thick as much as 50 μm in the adhesive film (comparative example 2), the resistance value in the thickness direction abruptly increases.

In addition, the adhesive film of embodiment 5 is formed by additionally injecting an anti-static agent when the adhesive layer is formed. Therefore, although thickness of the adhesive layer is not controlled to be extremely thin, adhesive reliability and release force between two materials are maintained as they are, and the resistance value in the thickness direction is decreased.

As described above, if thickness of an acrylic adhesive layer is controlled in an adhesive film, the resistance value in the thickness direction of the adhesive film, i.e., the resistance value in the direction where an electric field is formed, may be controlled within a range of 1.0×10⁴ to 9.9×10⁹Ω without changing adhesive properties and reliability of the adhesive layer. Accordingly, since loss of the applied voltage is minimized and the charged particles are freely driven, the driving voltage of a flexible display device is least affected.

In the dielectric adhesive film for an electronic paper display device of the present invention, a resistance value in the thickness direction of the adhesive film, i.e., a resistance value in the direction where an electric field is formed, may be controlled based on control on a structural property, i.e., thickness, of the adhesive film without changing adhesive properties and reliability.

Accordingly, a lower electrode to which voltage is applied and an image upper layer coated with charged particles whose colors are diversely changed depending on the applied voltage are attached to the dielectric adhesive film for an electronic paper display device of the present invention. At this point, a resistance value in the direction where an electric field is formed is controlled between 1.0×10⁴ and 9.9×10⁹Ω. Therefore, since loss of the applied voltage is minimized and the charged particles are freely driven, adhesive properties of the adhesive film are unaffected. Accordingly, since driving voltage of a flexible display device such as an electronic paper is least affected, and there is almost no loss of potential difference (voltage) when the flexible display device is driven, driving performance of the display device is excellent although a high voltage is not applied.

As described above, the present invention provides an adhesive film attaching an upper electrode coated with charged particles and a lower electrode to which voltage is applied. At this point, since thickness of the adhesive film is controlled to be uniform and constant, a resistance value in the thickness direction of the adhesive film, i.e., a resistance value in the direction where an electric field is formed, may be controlled within a range of 1.0×10⁴ to 9.9×10⁹Ω without changing adhesive properties and reliability of the adhesive film.

Therefore, since effect on the driving voltage of a flexible display device, such as a flexible light emitting diode (LED), an organic electro luminescence (EL) element including an electronic paper, and the like, is minimized, and there is almost no loss of potential difference (voltage) when the flexible display device is driven, driving performance of the display device is excellent although a high voltage is not applied.

Furthermore, the dielectric adhesive film for an electronic paper display device of the present invention may be reused.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

We claim:

1. A dielectric adhesive film for an electronic paper display device, said dielectric adhesive film being controlled and laminated to have a thickness of 4.0 to 50.0 μm to attach an upper electrode coated with charged particles and a lower electrode to which voltage is applied.

2. The film according to claim 1, wherein an electrical resistance value in a direction where an electric field is formed satisfies a range of 1.0×10⁴ to 9.9×10⁹Ω as the thickness is controlled.

3. The film according to claim 1, wherein in the adhesive film, an acrylic adhesive layer is formed on a silicon release coating surface of a polyester-based high release sheet to have a thickness of 4.0 to 50.0 μm, and a polyester-based low release sheet is laminated on the acrylic adhesive layer.

4. The film according to claim 3, wherein the acrylic adhesive layer is formed using an acrylate copolymer as a base resin, in which the acrylate copolymer is produced by copolymerizing 80 to 98% by weight of a monomer without a cross-linkable functional group and 2 to 20% by weight of a monomer having a cross-linkable functional group.

5. The film according to claim 4, wherein the monomer that does not have a cross-linkable functional group is an (meta)acrylic acid ester having an alkyl group of 1 to 20 carbon atoms in the ester portion selected from the group consisting of a methyl(meta)acrylate, ethyl(meta)acrylate, n-propyl(meta)acrylate, n-butyl(meta)acrylate, pentyl(meta)acrylate, hexyl(meta)acrylate, cyclohexyl(meta)acrylate, 2-ethylhexyl(meta)acrylate, isooctyl(meta)acrylate, decyl(meta)acrylate, dodecyl(meta)acrylate, myristyl(meta)acrylate, palmityl(meta)acrylate, stearyl(meta)acrylate, or n-tetradecyl(meta)acrylate; an acrylic monomer of acrylonitile; or a biacrylic monomer containing vinyl acetate or styrene; and a combination thereof.

6. The film according to claim 4, wherein the monomer having a cross-linkable functional group is a single or a mixture of two or more monomers selected from:
an acryl monomer containing any one hydroxy group selected from the group consisting of 2-hydroxy ethyl(meta)acrylate, 2-hydroxy propyl(meta)acrylate, 4-hydroxy butyl(meta)acrylate, 6-hydroxy hexyl(meta)acrylate, 2-hydroxy ethylene glycol(meta)acrylate, and 2-hydroxy propylene glycol(meta)acrylate;
an acryl monomer containing a carboxyl group of any one selected from the group consisting of (meta)acryl acid, maleic acid, and fumaric acid; and
any one nitrogen-containing acryl monomer selected from the group consisting of acryl amid, N-vinyl pyrrolidone, and N-vinyl caprolactam.

7. The film according to claim 3, wherein the acrylic adhesive layer contains 0.05 to 5 parts by weight of a single or a mixture form selected from an epoxy-based cross-linking agent or a multi-functional isocyanate-based cross-linking agent, with respect to 100 parts by weight of a base resin produced using an acrylate copolymer.

8. The film according to claim 3, wherein the acrylic adhesive layer further contains one or more of anti-static agents selected from the group consisting of a conductive organic-inorganic particle, organic-inorganic salt, and an ionic material.
